(19) United States
(12) Patent Application Publication
(10) Pub. No.: US 2014/0201926 A1
(43) Pub. Date: Jul. 24, 2014

(54) EDGE-BAND CHAMFERING MACHINE CAPABLE OF RECEIVING A TRIMMING TOOL

(71) Applicant: Chin-Chi Lin, Taichung City (TW)

(72) Inventor: Chin-Chi Lin, Taichung City (TW)

(21) Appl. No.: 13/748,337

(22) Filed: Jan. 23, 2013

(51) Int. Cl. B26B 27/00

(52) U.S. Cl. CPC B26B 27/00
USPC 7/158

(57) ABSTRACT

An edge-band chamfering machine includes a supporting frame unit, a driving unit, and a tool assembly. The supporting frame unit includes a mounting portion defining a vertical mounting hole, and a positioning portion having an abutment surface and a receiving groove. The driving unit is disposed within the mounting hole, and includes a spindle and a cutter disposed on the spindle. The tool assembly includes a connecting member disposed pivotally on the positioning portion, and a trimming tool disposed removably on the connecting member. The tool assembly is convertible between a tool-taking position, where the tool assembly extends outwardly from the abutment surface, and a tool-concealing position, where the tool assembly is concealed within the receiving groove.

### BACKGROUND OF THE INVENTION

1. Field of the Invention

This invention relates to a chamfering machine, and more particularly to an edge-band chamfering machine capable of receiving a trimming tool.

2. Description of the Related Art

Referring to FIG. 1, a conventional edge-band chamfering machine includes a supporting frame unit 11 having a sleeve portion 111 and a positioning portion 112 extending laterally from the sleeve portion 111, and a driving unit 12 disposed within the sleeve portion 111. The driving unit 12 includes a housing 121, a motor 122 disposed within the housing 121, and a cutter 123 driven by the motor 122 and disposed outwardly of the sleeve portion 111.

To chamfer a top side of an edge band 100 adhered to a side surface 102 of a workpiece 101, the bottom surface of the positioning portion 112 is brought into contact with the top surface 103 of the workpiece 101, and, subsequently, the cutter 123 is moved along the edge band 100.

However, when the edge band 100 is thin, since the edge-band chamfering machine is bulky, and since the power output of the motor 122 is relatively large, it is difficult to use the edge-band chamfering machine, and too many chips are produced, so that a manual trimming tool is required, thereby resulting in inconvenience during use.

### SUMMARY OF THE INVENTION

The object of this invention is to provide an edge-band chamfering machine capable of receiving a trimming tool to increase applicable range of the edge-band chamfering machine.

According to this invention, an edge-band chamfering machine includes a supporting frame unit, a driving unit, and a tool assembly. The supporting frame unit includes a mounting portion defining a vertical mounting hole, and a positioning portion having an abutment surface and a receiving groove. The driving unit is disposed within the mounting hole, and includes a spindle and a cutter disposed on the spindle for performing a chamfering operation on an edge band. The tool assembly includes a connecting member disposed pivotally on the positioning portion, and a trimming tool disposed removably on the connecting member. The tool assembly is convertible between a tool-taking position, where the tool assembly extends outwardly from the abutment surface, and a tool-concealing position, where the tool assembly is concealed within the receiving groove.

Due to the presence of the tool assembly, the applicable range of the edge-band chamfering machine is increased.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a schematic view illustrating use of a conventional edge-band chamfering machine;

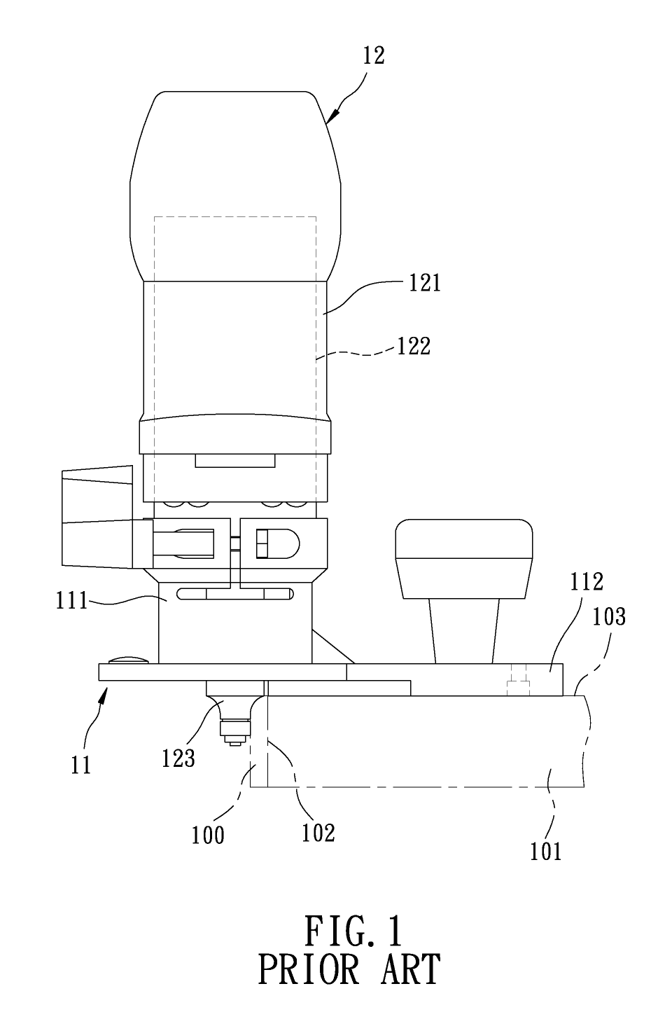

FIG. 2 is an assembled perspective view of the preferred embodiment of an edge-band chamfering machine according to this invention;

FIG. 3 is an exploded top perspective view of the preferred embodiment;

FIG. 4 is an exploded bottom perspective view of the preferred embodiment;

FIG. 5 is a schematic sectional view of the preferred embodiment, illustrating a tool-concealing position of a tool assembly;

FIG. 6 is a view similar to FIG. 5 but illustrating a tool-taking position of the tool assembly; and

FIG. 7 is a schematic view illustrating use of the preferred embodiment.

### DETAILED DESCRIPTION OF THE PREFERRED EMBODIMENT

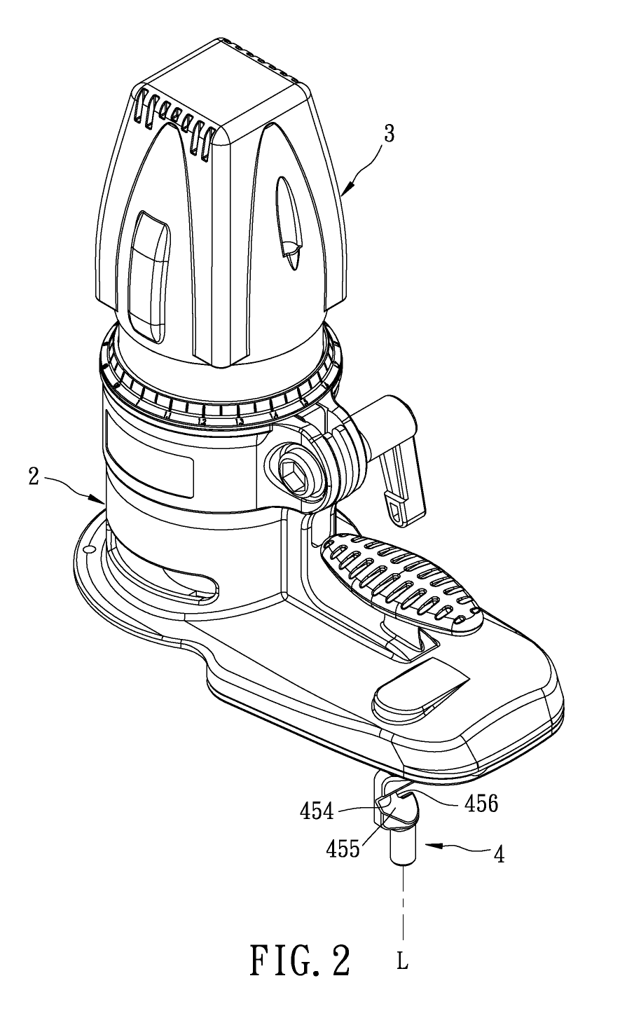

Referring to FIGS. 2, 3, and 4, the preferred embodiment of an edge-band chamfering machine according to this invention includes a supporting frame unit 2, a driving unit 3, and a tool assembly 4.

The supporting frame unit 2 includes a mounting portion 21 defining a vertical mounting hole 22, and a positioning portion 23 extending laterally from the mounting portion 21.

The positioning portion 23 has a downwardly facing horizontal abutment surface 26 disposed at a bottom side thereof, a receiving groove 27 formed in the abutment surface 26, an upper shell 24, and a lower shell 25 connected to the upper shell 24. The lower shell 25 has a base wall 251, two lugs 252 extending upwardly from the base wall 251 and spaced apart from each other, a vertical stop wall 253 extending upwardly from the base wall 251 and located at a side of the lugs 252, two sidewalls 254 extending upwardly from the base wall 251 and located at an opposite side of the lugs 252, a top stop wall 255 connected between the sidewalls 254, and a stop seat 256 connected to the base wall 251. The abutment surface 26 is disposed at a bottom side of the base wall 251. The receiving groove 27 is defined by the lugs 252, the vertical stop wall 253, the sidewalls 254, and the top stop wall 255. The stop seat 256 defines a slide slot 257 in spatial communication with the receiving groove 27.

The driving unit 3 is disposed within the mounting hole 22 in the supporting frame unit 2, and includes a housing 31, a motor 32 disposed within the housing 31, a spindle 33 driven by the motor 32, and a cutter 34 disposed on the spindle 33 for performing a chamfering operation.

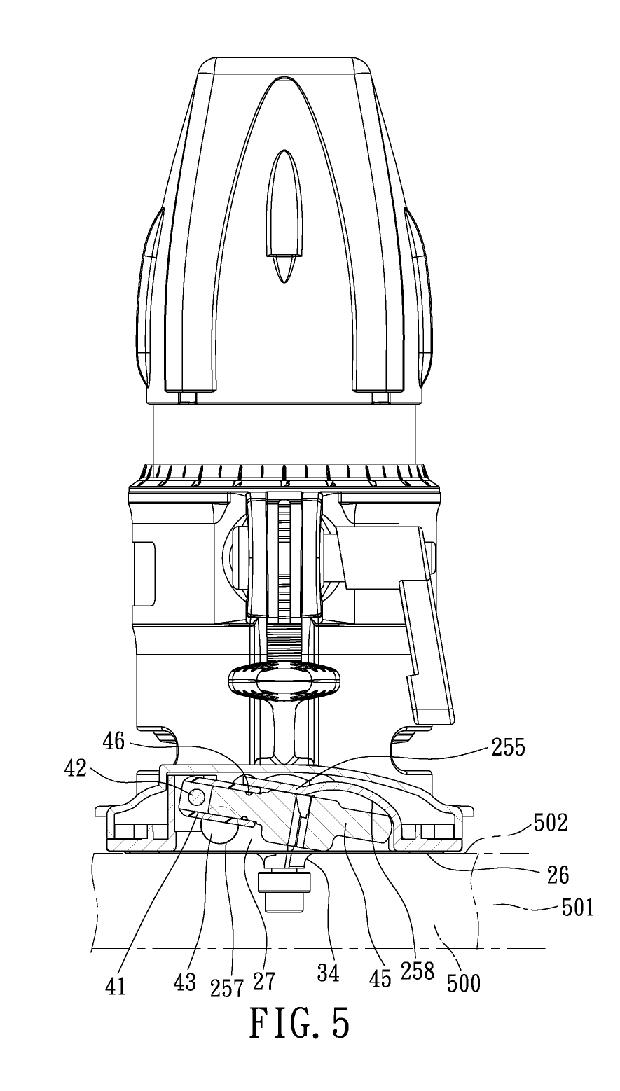

The tool assembly 4 includes a connecting member 41 disposed pivotally on the positioning portion 23, a pivot pin 42 for connecting the connecting member 41 pivotally between the lugs 252, a stop member 43 disposed movably in the slide slot 257, a resilient member 44 disposed in the slide slot 257 for biasing the stop member 43, a trimming tool 45 disposed removably on the connecting member 41 and extending along a central axis L, and a cushion ring 46 sleeved on the trimming tool 45. In this embodiment, the connecting member 41 is hollow and cylindrical, the stop member 43 is spherical, and the pivot pin 42 is parallel to and vertically and horizontally misaligned from the slide slot 257, as shown in FIG. 5.

The connecting member 41 is sleeved rotatably on the pivot pin 42, and has an insert hole 411. The trimming tool 45 has an insert section 451 sleeved by the cushion ring 46 and inserted removably into the insert hole 411, a tool body 452 connected to the insert section 451, and a grip portion 453 connected to an end of the tool body 452 distal from the insert section 451. In this embodiment, the insert section 451 is formed with an annular groove 457 for receiving the cushion ring 46.

The tool body 452 has a first base surface 454, a second base surface 455 perpendicular to the first base surface 454, and a blade portion 456 disposed between the first and second base surfaces 454, 455. In this embodiment, the central axis L extends through the first and second base surfaces 454, 455. In an alternative embodiment, the first and second base surfaces 454, 455 may be parallel to the central axis L.

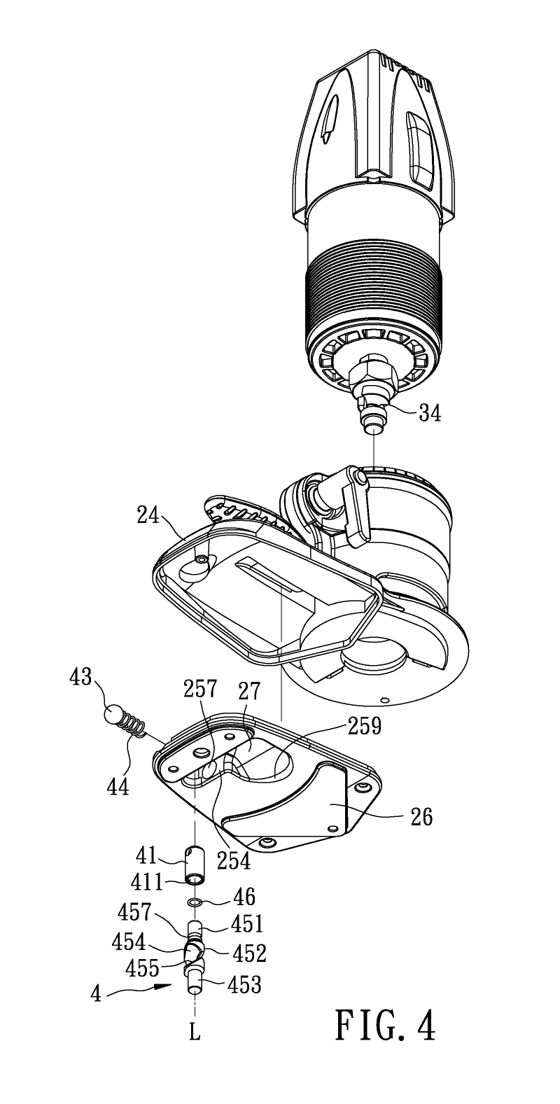

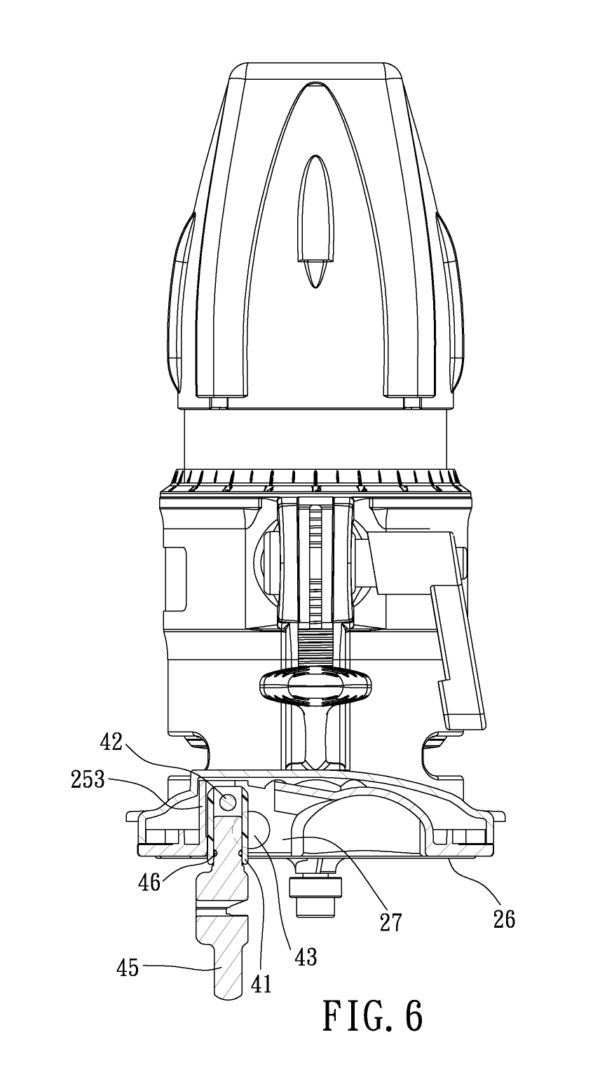

With further reference to FIGS. 4, 5, and 6, the tool assembly 4 is convertible between a tool-taking position shown in FIG. 6 and a tool-concealing position shown in FIG. 5. In the tool-taking position, the tool assembly 4 extends outwardly from the abutment surface 26, and the trimming tool 45 can be removed from the connecting member for performing a chamfering operation. In the tool-concealing position, the tool assembly 4 is concealed within the receiving groove 27. The resilient member 44 biases the stop member 43 to press against the connecting member 41 for maintaining the tool assembly 4 at the tool-taking position and the tool-concealing position.

As such, the connecting member 41 is rotatable about the pivot pin 42, and is perpendicular to the abutment surface 26 when the tool assembly 4 is at the tool-taking position.

In this embodiment, a bottom surface of the top stop wall 255 has a concaved surface portion 258 (see FIG. 5) aligned with the grip portion 453 and concaved away from and spaced apart from the grip portion 453. One of the sidewalls 254 has a curved portion 259 (see FIG. 4) extending from the remaining portion of the one of the sidewalls 254 in a direction away from the grip portion 453. As such, one hand of the user can be moved easily into the receiving groove 27 to hold the grip section 453, such that the trimming tool 45 is convenient to operate. The stop member 43 is biased to press the connecting member 41 against the top stop wall 255 when the tool assembly 4 is at the tool-concealing position, and against the vertical stop wall 253 when the tool assembly 4 is at the tool-taking position.

During pivoting movement of the connecting member 41, the stop member 43 is confined within the slide slot 257 by the connecting member 41. When the tool assembly 4 is at the tool-concealing position or the tool-taking position, the stop member 43 is biased by the resilient member 44 to press against the connecting member 41 at a position misaligned from the rotating axis of the connecting member 41, so as to maintain the position of the connecting member 41.

To chamfer an edge band 500 adhered to a workpiece 501, the tool assembly 4 is first converted into the tool-concealing position. Next, the abutment surface 26 is bright into contact with the top surface 502 of the workpiece 501. Hence, the cutter 34 can be moved to perform a chamfering operation on the top side of the edge band 500.

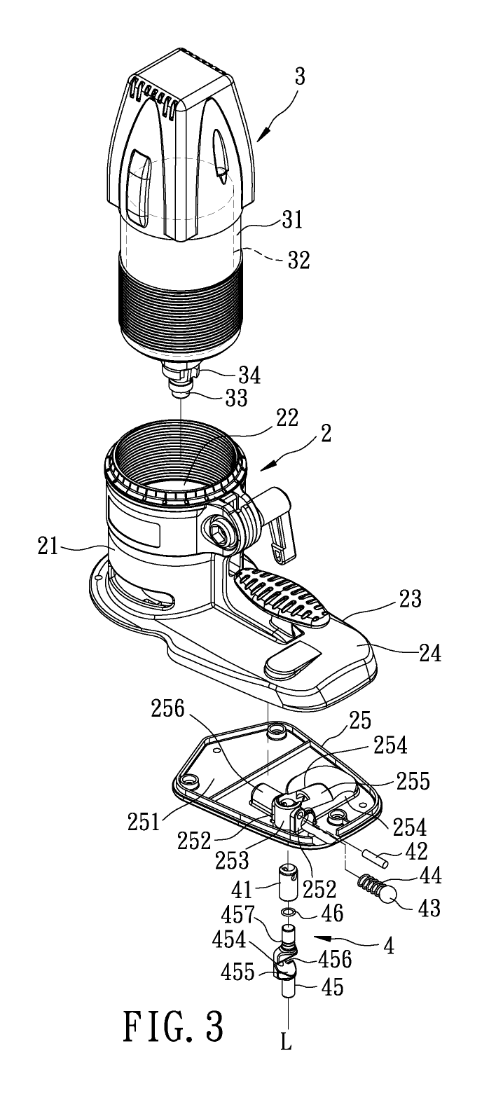

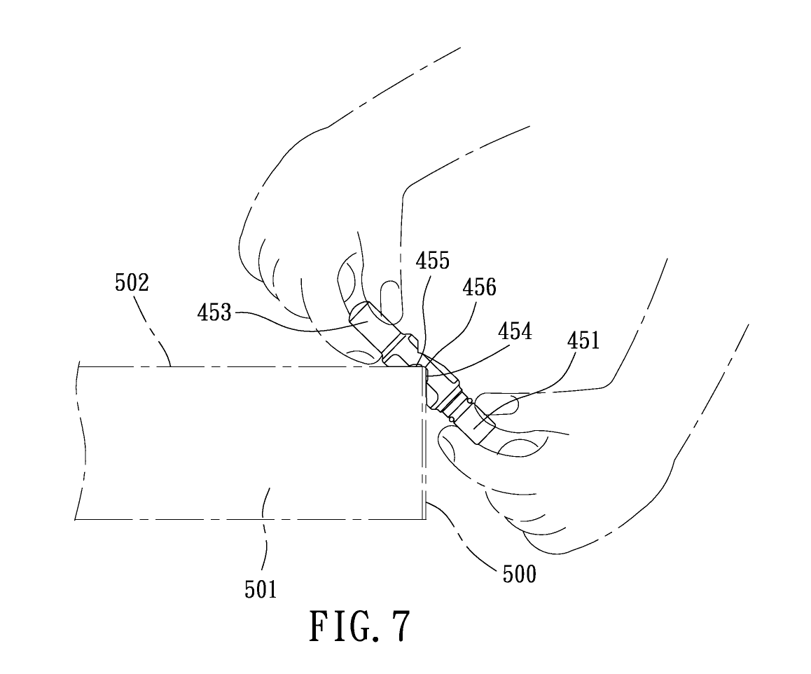

With particular reference to FIGS. 3, 6, and 7, in a situation where the edge band 500 is too thin to be chamfered using the cutter 34, the tool assembly 4 is adjusted to the tool-taking position, after which the trimming tool can be removed from the connecting member 41. Subsequently, the first and second base surfaces 454, 455 are brought into contact with the top surface 502 of the workpiece 501 and the edge band 500, respectively, so that the user can hold and move the insert section 451 and the grip section 453 to thereby chamfer the edge band 500 by use of the blade portion 456. As such, since the trimming tool 45 is received removably within the receiving groove 27, the edge band 500 can be chamfered by the cutter 34 or the trimming tool 45 according to the thickness of the edge band 500, so as to increasing convenience during use.

It should be noted that, if the connecting member 41, the pivot pin 42, and the lugs 252 are sized to create a sufficient friction, the stop member 43, the resilient member 44, and the stop seat 255 can be omitted.

In view of the above, due to disposition of the tool assembly 4 within the receiving groove 27, if necessary, the trimming tool 45 can be removed from the receiving groove 27 for use in a chamfering operation. As a consequence, the applicable range of the edge-band chamfering machine of this invention can be increased effectively. Thus, the object of this invention can be achieved.

With this invention thus explained, it is apparent that numerous modifications and variations can be made without departing from the scope and spirit of this invention. It is therefore intended that this invention be limited only as indicated by the appended claims.

I claim:

1. An edge-band chamfering machine comprising:
a supporting frame unit including a mounting portion defining a vertical mounting hole, and a positioning portion extending laterally from said mounting portion and having a horizontal abutment surface, and a receiving groove formed in said abutment surface;
a driving unit disposed within said mounting hole in said supporting frame unit and including a housing, a motor disposed within said housing, a spindle driven by said motor, and a cutter disposed on said spindle for chamfering; and
a tool assembly including a connecting member disposed pivotally on said positioning portion, and a trimming tool disposed removably on said connecting member and extending along a central axis, said tool assembly being convertible between a tool-taking position, where said tool assembly extends outwardly from said abutment surface to allow said trimming tool to be removed from said connecting member for chamfering, and a tool-concealing position, where said tool assembly is concealed within said receiving groove.

2. The edge-band chamfering machine as claimed in claim 1, wherein said positioning portion further has an upper shell and a lower shell connected to said upper shell, said lower shell having a base wall formed with said abutment surface, two lugs extending upwardly from said base wall, a vertical stop wall extending upwardly from said base wall and located at a side of said lugs, two sidewalls extending upwardly from said base wall and located at an opposite side of said lugs, and a top stop wall connected between said sidewalls, said tool assembly further including a pivot pin for connecting said connecting member pivotally between said lugs, said receiving groove being defined by said lugs, said vertical stop wall, said sidewalls, and said top stop wall.

3. The edge-band chamfering machine as claimed in claim 2, wherein said lower shell further has a stop seat connected to said base wall and defining a slide slot in spatial communication with said receiving groove, said tool assembly further including a stop member disposed movably in said slide slot, and a resilient member for biasing said stop member to press against said connecting member for maintaining said tool assembly at the tool-taking position and the tool-concealing position.

4. The edge-band chamfering machine as claimed in claim 3, wherein said connecting member is hollow and cylindrical, said stop member being spherical, said pivot pin being parallel to and vertically and horizontally misaligned from said slide slot such that, when said tool assembly is at the tool-taking position, said stop member is biased to press said connecting member against said vertical stop wall, and when said tool assembly is at the tool-concealing position, said stop member is biased to press said connecting member against said top stop wall.

5. The edge-band chamfering machine as claimed in claim 2, wherein said trimming tool has a grip section, said top stop wall having a bottom surface that has a concaved surface portion, said concaved surface portion being aligned with said grip section and being concaved upwardly away from and spaced apart from said grip portion, one of said sidewalls having a curved portion that is aligned with said grip section and that extends from the remaining portion thereof in a direction away from said grip section.

6. The edge-band chamfering machine as claimed in claim 1, wherein said tool assembly further includes a cushion ring sleeved on said trimming tool, said connecting member having an insert hole, said trimming tool having an insert section sleeved by said cushion ring and inserted removably into said insert hole, and a tool body connected to said insert section, said tool body having a first base surface, a second base surface perpendicular to said first base surface, and a blade portion disposed between said first and second base surfaces.

7. The edge-band chamfering machine as claimed in claim 6, wherein said trimming tool further has a grip section extending from an end of said tool body distal from said insert section.

8. The edge-band chamfering machine as claimed in claim 7, wherein said central axis extends through said first and second base surfaces.
